(19) United States
(12) Patent Application Publication
(10) Pub. No.: US 2004/0240315 A1
(43) Pub. Date: Dec. 2, 2004

(54) Slotted draft tube mixing systems

(76) Inventors: Prakash G. Balan, Wilmington, DE (US); John R. McWhirter, Boalsburg, PA (US)

Correspondence Address: Pamela A. Ruest, Esq., McQuaide Blasko, 811 University Drive, State College, PA, 16801-6699, US

(21) Appl. No.: 10/452,391

(22) Filed: Jun. 2, 2003

(51) Int. Cl. B01F 7/00; B01F 5/12

(52) U.S. Cl. 366/246

(57) ABSTRACT

A draft tube mixing system or reactor wherein the draft tube contains slots, perforations, or cut-out sections that allow cross flow of fluid through the draft tube wall. The perforations or slots can be practically any shape, however, simple geometric shapes such as rectangles and circles are preferred for ease of manufacture. The perforations or slots are typically arrayed in columns along a substantial section of the draft tube. In a preferred embodiment, the quantity and position of the perforations are such that a fluid filling the draft tube is capable of cross flow through the draft tube wall along substantially its entire length.

### FIELD OF THE INVENTION

The present invention relates generally to draft tube fluid mixing systems. More specifically, the invention relates to draft tube mixing systems wherein the draft tube has slots, perforations or openings to allow cross flow of fluid through the draft tube wall, particularly when the draft tube is not fully submerged in the fluid.

### BACKGROUND OF THE INVENTION

Fluid mixing is a fundamental need in many industrial processes including wastewater treatment, pulp and paper manufacture, food processing, and pharmaceutical manufacture. A fairly simple and traditional method of meeting this need is to submerge one or more mixing impellers attached to a shaft that is connected to a motor through a gearbox. The mixing effectiveness of this approach can be enhanced through the specific design of the system components. For example, the number and type of mixing impellers, the diameter of the impellers, and the shaft rotational speed can be chosen to achieve the desired level of mixing for the specific fluid being mixed. In addition, baffles are often included in the tank to improve mixing effectiveness.

This traditional type of mixing system involving multiple impellers on a common shaft results in a complex flow field in single phase systems and grows more complex in multiphase systems where the phases could be some combination of gas, liquid and solid. One example of such a multiphase system is the aeration of wastewater where a critical determinant of performance is the oxygen transfer efficiency of the system. This efficiency is partly determined by the mixing process and the traditional mixing tank configuration can be further improved, especially in such multiphase systems. One way of enhancing such mixing is through the use of a draft tube. In draft tube mixing systems, a usually cylindrical tube open at both ends is disposed vertically and concentrically inside the tank creating a cylindrical space inside the draft tube and an annular space outside the draft tube. A shaft containing one or more mixing impellers is operated inside this draft tube causing significant vertical fluid flow in both the cylindrical space inside the draft tube and the annular space outside the draft tube thus enhancing the overall mixing action. Many variations on this typical draft tube mixing system design are possible. For example, additional impellers can be located on the shaft outside the draft tube and baffles can be located on the inside of the draft tube for additional mixing enhancement.

Some prior art examples of draft tube mixing systems include U.S. Pat. No. 5,314,076 (referred to herein as “La Place”), U.S. Pat. No. 4,919,849 (referred to herein as “Litz”), U.S. Pat. No. 4,798,131 (referred to herein as “Ohta”), U.S. Pat. No. 4,699,740 (referred to herein as “Bollenrath”), U.S. Pat. No. 3,460,810 (referred to herein as “Mueller”), and U.S. Pat. No. 3,092,678 (referred to herein as “Braun”) and WIPO publication WO 01/41919 (referred to herein as “Kar”).

These prior art patents and WIPO publication give an indication of the variety of applications wherein draft tube mixing systems have been employed. La Place discloses a mixing system designed for treatment of stored waste or filtered water by the transfer of an oxidizing gas in this water. This mixing system contains a draft tube for increasing the efficiency of dissolving the treatment gas. Litz teaches a gas-liquid mixing process and apparatus that uses a helical down pumping impeller inside a draft tube. Ohta describes a method and apparatus for tartars separation. The apparatus has a draft tube centered in the lower half of the tank creating a circulation that induces crystal growth and removal of tartars from the liquid. Bollenrath discloses a stirring system and method for introducing gases into liquids. This system also contains a draft tube for increasing circulation and enhancing the dispersion of gases. It also demonstrates the uses of mixing impellers both inside and outside the draft tube. Mueller teaches a mixing system that has multiple tubular elements submerged concentrically within the tank. The inner element is termed a “baffle” and has holes in its surface to enhance gas dispersion. The figures of Braun depict a very basic draft tube mixing system for gasifying liquids. This design appears to have a minimum of impellers and baffles. Lastly, Kar discloses a draft tube mixer system useful for gas-liquid reactions. Kar further teaches that his draft tubes can have slots but does not provide any practical examples of such.

While these prior art examples of draft tube mixing systems can be very effective in many operations, there are some disadvantages to them. Perhaps the primary disadvantage is that the draft tube must be totally submerged in order to operate effectively as a draft tube. If the draft tube is not totally submerged, fluid cannot flow circularly through the draft tube and through the annular space in the opposite direction. This is not a problem if the mixing system is always operated at a fluid level above the top of the draft tube. However, manufacturing reality is that it is often desirable to perform industrial fluid processes at lower fluid levels, which would not result in the draft tube being fully submerged.

An example of such a situation is a staged batched reaction process when not all ingredients are added at the beginning of the process. In this situation, a portion of the ingredients may be initially added to the mixing tank and reacted or mixed for a period of time before adding the remaining components and continuing the process. This could occur in two or more stages. Effective mixing in these situations may require removing the draft tube for the entire process or at least until enough ingredients have been added so that the draft tube would be fully submerged when reinstalled. However, removing and reinstalling a draft tube is impractical on a commercial scale system. Where possible, it is time consuming, inefficient, and increases the likelihood of damage to the mixing system. It would be desirable to have a draft tube mixing system that can provide effective mixing even when the draft tube is not fully submerged. The present invention addresses this need.

Accordingly, the following are selected objects of various embodiments of the present invention:

It is an object of the present invention to provide a draft tube for mixing systems wherein the draft tube is designed to allow cross flow of fluid through the draft tube wall.

It is also an object of the present invention to avoid the disadvantages of operating traditional draft tube mixing systems with a fluid level below the top of the draft tube.

It is an object of the present invention to provide a slotted or perforated draft tube that does not significantly reduce axial flow of fluid through the draft tube during normal mixing system operation when the draft tube is fully submerged.

### SUMMARY OF THE INVENTION

The invention is a draft tube fluid mixing system, wherein the draft tube contains slots, perforations, or openings permitting cross flow of fluid through the draft tube wall. The perforations or slots may be of many different shapes including rectangles and circles and are of a size and position that allows the desired level of cross flow through the draft tube wall without significantly degrading the axial flow of fluid through the draft tube during when the draft tube is fully submerged below the static liquid level.

### BRIEF DESCRIPTION OF THE DRAWINGS

FIG. 1 shows a diagrammatic, sectional front elevational view of a tank containing a mixing impeller system in accordance with the invention. Note that this figure does not illustrate the openings in the draft tube.

FIG. 2 shows a view of the draft tube mixing system according to the present invention wherein the draft tube contains a slot 1 pattern according to FIG. 3D.

FIGS. 3 and 4 show example opening designs that can be used as the slots, perforations, or openings on the draft tube surface. The designs can be placed over the entire, or only a portion of, the draft tube of the present invention.

### DETAILED DESCRIPTION OF THE INVENTION

The invention, in its simplest embodiment, is a draft tube fluid mixing system where the draft tube has slots, perforations, or openings of a size and quantity that allow for a desired amount of cross flow of fluid through the draft tube wall. The invention also includes a fluid mixing system containing such a draft tube. The fluid mixing system of the invention contains: (1) a tank or other fluid retaining device, (2) the perforated draft tube positioned generally vertically and concentrically within the tank, and (3) a shaft containing one or more mixing impellers positioned within the draft tube (and optionally additional mixing impellers located outside the draft tube). In preferred embodiments, the fluid mixing system has a more specific design which is discussed in more detail below. While we denote such systems, “draft tube mixing systems” the term “draft tube reactor” also applies and may be used interchangeably herein.

The draft tubes of the invention are specially designed to allow for cross flow of fluid through the draft tube wall. By “cross flow” is meant the flow of fluid through the wall of the draft tube and not through either end of the draft. This is generally a direction of flow that is perpendicular to the axis of the draft tube and that is perpendicular to the normal fluid flow inside the draft tube when the mixing system is in operation. Cross flow allows fluid to travel from inside the draft tube to the annular space outside the tube without going through either open end of the draft tube. This ability is particularly advantageous when the mixing system is operating with a fluid level that is not above the top level of the draft tube. “Normal” operation of a draft tube mixing system occurs only when the fluid level is above the top of the draft tube thus allowing fluid to flow lengthwise/vertically through the draft tube and in the opposite direction in the annular region outside the draft tube. However, there are times when it is desirable to operate a fluid mixing system at a lower fluid level, as is often the case with batch type operations (e.g. reactions) that are done in multiple stages wherein not all components are added to the mixing vessel at the beginning of the operation. The present invention is generally useful in situations where the benefits of a draft tube are frequently needed, but the capability of operating a mixing tank at less than full capacity (fluid level above the draft tube) is required. The inventive draft tube will avoid the necessity of accepting poor mixing performance or possibly having to remove the draft tube during such less than full capacity operations.

Cross flow through the draft tube wall is achieved by means of slots, perforations, or openings in the draft tube wall. Whether the term “slots”, “perforations”, or “openings” is used, what is meant is that the walls of the draft tube contain holes or cutout sections that will allow fluid to flow from inside the draft tube to the annular region outside the draft tube without traveling through either end of the draft tube. In the broader embodiment of the invention, the specific shape and pattern of the perforations is not particularly limited and will most likely be chosen according to ease (or cost) of manufacture. Simple geometric shapes including rectangles, squares, circles, and ovals are some preferred examples. Also the positioning of the perforations is also not particularly limited although columns or arrays of cutouts may be more practical than random positions depending on the method of manufacture. Furthermore, the perforations (e.g. columns and/or rows of cutout sections) may be positioned entirely around the circumference of the draft tube or may only be positioned on a portion thereof, for example approximately 60%, 50%, or 25% thereof.

The size and number of slots, perforations, or openings can also vary considerably. In some embodiments of the invention there may be many smaller openings or there could just as easily be fewer larger openings to produce the same amount of open area. The concept of hydraulic diameter is a useful means to describe the size of the openings. The hydraulic diameter is defined as 4 times the area of the opening divided by its wetted perimeter. For a circular opening, the hydraulic diameter is the diameter of the circle. Thus, the hydraulic diameter is a means of characterizing an opening of any shape according to its circular hydraulic equivalent. In the present invention, openings having a hydraulic diameter of from 1 to about 12 inches are preferred. In some embodiments of the invention it is preferred to have a hydraulic diameter of greater than 2 inches. In one example, the hydraulic diameter is greater than 4 inches.

Another way of characterizing the slots, perforations, or openings is to give the total open surface area of the perforations as a percentage of the total inside surface area of the draft tube. Some important considerations with respect to the size of the perforations (or total open surface area) are: (1) that they must be sufficient to allow the desired level of cross flow through the draft tube wall, (2) that they must not be so large as to significantly degrade axial flow of fluid during normal operation of the mixing system, and (3) that they must not be so large as to significantly reduce the rigidity or stability of the draft tube which would make the draft tube difficult to handle or maintain and perhaps reduce its useful life.

While the parameters discussed above are the best way to describe the limitation on the total perforation surface area, we believe that the perforation surface area should be at least 5%, possibly at least 10%, or even 20% of the total draft tube inside surface area. The deleterious effects of the perforations will determine the upper limit of the perforation surface area, namely the reduced rigidity of the draft tube and the reduced vertical circulation in the tank and the annular region. Accordingly, it is difficult to give a precise upper limit especially since the deleterious effect may vary significantly with the variation in physical properties (e.g. thickness, viscosity) of the fluid being mixed. However, we believe that a total perforation surface area as a percentage of the total draft tube inside surface area above 50%, 40%, or even above about 30% may not allow for effective mixing when in normal operation.

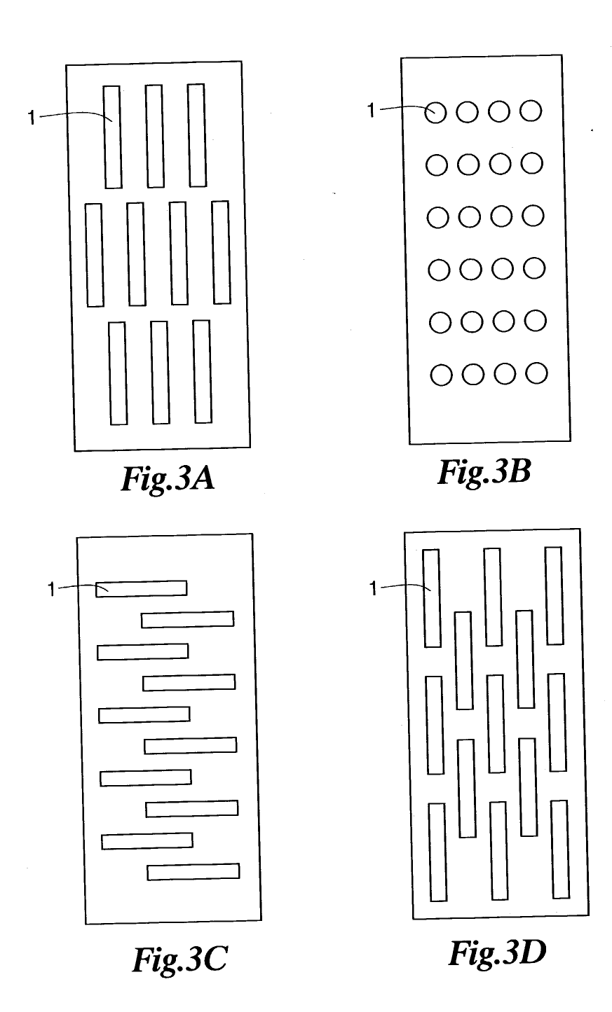

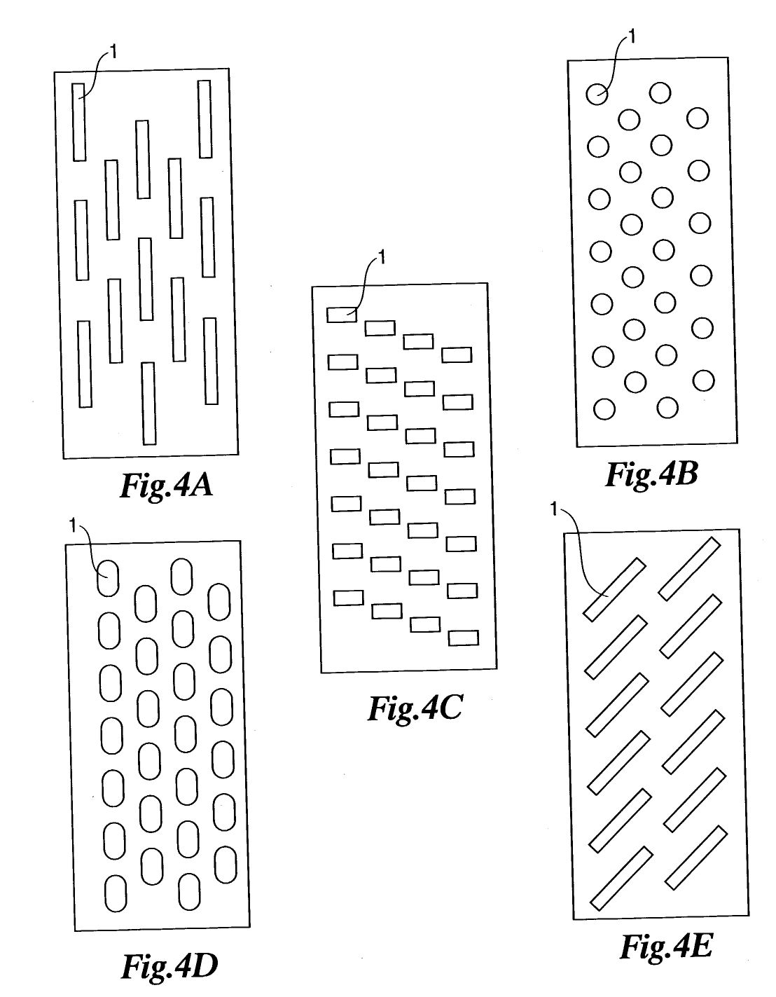

Some preferred designs for the perforation 1 pattern are shown in FIGS. 3 and 4. FIGS. 3A, 3D, and 4A show vertical rectangular openings wherein each rectangle is between ¼^{th} and ⅓^{rd} of the height of the draft tube. Preferably the rectangular openings have height at least 1/10^{th} or at least ⅕^{th} the height of the draft tube. Note that in design 3A, the bottom of the top row of rectangles does not overlap the top of the next lower row of rectangles. This is not true of the designs shown in FIGS. 3D and 4A wherein adjacent columns of vertical rectangles are offset such that a slot, in an adjacent column, always spans the vertical distance defined by the top of a slot and the bottom of the next higher slot. This is referred to herein as an “offset” or rectilinear design and is a most preferred embodiment of the invention. More generally, these most preferred embodiments are those perforated draft tube designs that are capable of cross flow through the draft tube wall along substantially the entire length of the draft tube. By “substantially” the entire length is meant that the perforations typically will not go all the way to the top or bottom of the draft tube to avoid decreased strength and stability of the draft tube. Another way of describing these preferred embodiments is the following. Except for near the top and bottom of the draft tube, any disc shaped slice of the draft tube will cut across at least one slot or perforation of the draft tube. This ensures that cross flow through the draft tube wall is always possible (except near the very top and bottom of the draft tube).

FIGS. 3A-3C, and 4B are not offset designs of the type just described because cross flow through the draft tube wall can not occur at all vertical locations within the draft tube. In these designs, there is a vertical section between rows of slots that will not allow cross flow through the draft tube wall at that fluid level. FIGS. 3D, 4A, 4C, 4D, and 4E are of the more preferred type that allow cross flow through the draft tube wall along substantially the entire length of the draft tube. FIGS. 3D and 4A show vertical rectangular slots, FIG. 4C shows horizontal rectangles in a series of stepping patterns, and FIG. 4D shows offset columns of generally oval shapes slots.

In another embodiment of the invention, the slots, perforations, or openings are designed to be variable. By “variable” it is meant that the size or number of the openings can be changed relatively easily. Thus the total open surface area of the draft tube can be adjusted to best fit the circumstances of each particular use. There are many ways of varying the size of an opening and the invention should not be limited to any particular method. We will provide two examples. In a first example, each opening can independently have a sliding cover attached to either the inside or outside of the draft tube that can be adjusted to partially or completely cover each opening. In a second example, the draft tube consists of two cylindrical tubes mated concentrically close together but independently movable. In this example each tube has openings (either the same or different) and cross flow through the draft tube wall is only possible when the openings are aligned. Thus by moving one tube vertically along axis or rotating it around the axis in relation to the other the openings can range continuously from completely aligned to completely miss-aligned resulting in the slots varying continuously from completely open to completely closed. These variable slots increase the complexity of the design and have the disadvantages of being more difficult to make, clean, and maintain, but may be useful in situations where the benefits of having a variable slot surface area are needed.

In yet another embodiment of the invention, the draft tube may have zones wherein the slots in different zones are of different shapes or sizes. For example, the draft tube may be divided into halves, thirds, or fourths along its axis with different sized slots in each zone. For example, slots in only the bottom zone (or in the bottom and top zones) may be larger to optimize the desired goals of effective cross flow through the draft tube wall and effective axial mixing. Additionally, there may be zones without any slots. All these variations are within the scope of the invention.

The method of manufacturing the slotted or perforated draft tube is not strictly a part of the invention as it can be made by various methods known in the art. For example, the perforations can be made by a punching or stamping type technique on sheet metal. Also, the perforations can be made by numerous available cutting techniques such as sawing, laser cutting, etc. The inventors hereof do not wish to be bound by any such techniques, as it will be obvious to those skilled in the art that a variety of other options can be used.

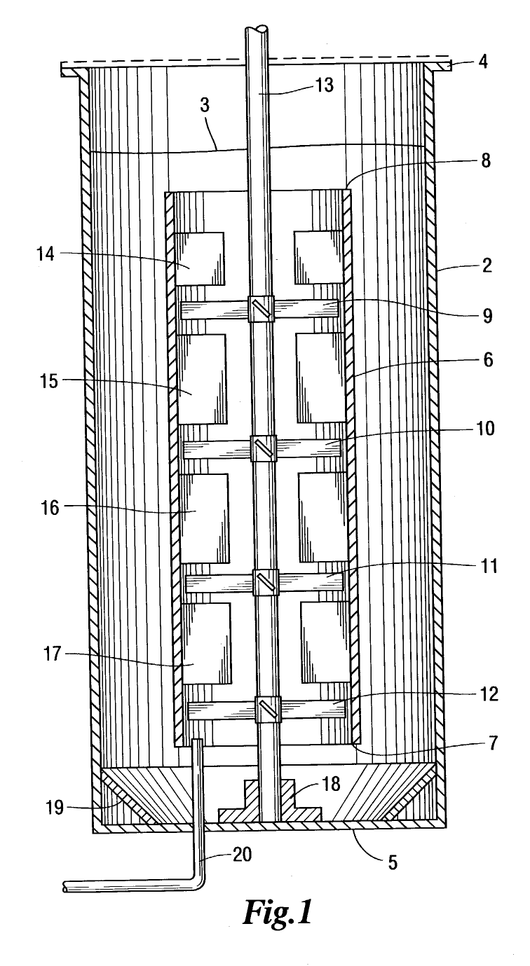

In a preferred embodiment of the invention, the perforated draft tube is used in the draft tube mixing system described in U.S. Pat. Nos. 5,972,661 and 6,464,384 both of which are incorporated herein by reference in their entirety for their description of such draft tube mixing systems. A description of such mixing systems in accordance with these patents will now be given—first with a description of the embodiments shown in FIGS. 1 and then more generically.

As shown in FIG. 1, the liquid is in a tank 2 and has a static liquid level 3 below the upper end or rim 4 of the tank when the liquid in the tank is not being mixed (circulated or turned over) between the surface 3 and the bottom 5 of the tank. The tank 2 may be generally cylindrical and the tank walls arranged vertically upright. A cylindrical draft tube 6 is mounted preferably centrally in the tank. Then the axis of the draft tube 6 is coincident with the axis of the tank 2 when the tank is cylindrical. The diameter of the draft tube and its length is such that the internal volume defined by the draft tube 6 is a substantial part, at least 25% and preferably 50% of the volume of the liquid in the tank. There is clearance between the bottom 5 of the tank and the lower end 7 of the draft tube. The upper end 8 of the draft tube is in the vicinity of the static liquid surface 3. A plurality of mixing impellers 9-12 are attached to, and driven by, a common shaft 13. The upper end of the shaft may be connected to a drive motor via a gear box (not shown) and the lower end of the shaft 13, may be journaled in a steady bearing 18. The impellers are all of the same type, namely so-called pitched blade turbines (PBT), having a plurality of four blades circumferentially spaced about the axis of rotation, the axis being the axis of the shaft 13 and the blades are disposed at 45° to that axis. Other axial flow impellers may be used, such as airfoil-type blades (sometimes called hydrofoil blades described in Weetman, U.S. Pat. No. 4,896,971. Other air foil impellers which may be suitable are described in U.S. Pat. No. 4,468,130, also issued to Weetman.

The mixing system in the draft tube also includes sets 14-17 of four vertical baffles which are 90° displaced circumferentially about the axis of the shaft 13 and between the impellers. Other sets of baffles may be located above and, if desired below, the upper and lower most impellers 9 and 12. In other words, two pairs of baffles are contained in each set and the pairs are 180° displaced with respect to each other. The impellers 9-12, with the aide of the sets of baffles 14-17, produce a field or pattern of agitation which provide a high level of shear coupled with a high volume of axial liquid flow in the draft tube. Thus, in the case of non-Newtonian, shear-thinning liquids, the viscosity of the liquid in the draft tube is maintained sufficiently low so that it enhances mass transfer and promotes improved circulation in the tank. The circulation, which has been found to produce the most effective mixing, is in the upward direction inside the draft tube to regions at the ends of the draft tube 7 and 8 where the flow changes direction, so that the flow is downward in the annular region between the draft tube 6 and the sidewall of the tank 2.

The annular region between the draft tube wall 6 and the sidewall of the tank 2 is a region of low shear and hence high effective viscosity for shear thinning liquids. Nonetheless, good uniform flow with no stagnant regions is maintained down through this high viscosity annular region by virtue of the high flow rate generated up through the low viscosity draft tube zone. Thus, the annular region between the draft tube wall 6 and the sidewall of the tank 2 has a relatively high average axial fluid velocity and the liquid is quickly recirculated into the high shear, low viscosity draft tube region.

The relative sizing of the draft tube diameter and impellers and their locations in the draft tube are related by the flow rate so that the requisite circulation and mixing may be obtained. Then the rate of flow and volume contained in the draft tube and the volume of the tube are sufficient to establish the axial flow between the tube and wall of the tank over a broad range of viscosities up to and including viscosities of the order of 10⁴ cp (Brookfield).

In the case of a flat-bottomed tank, to prevent stagnant zones at the corner formed by the sidewall and the bottom 5 of the tank 2, it is desirable to install an annular plate or ring 19 which defines a fillet to smooth the flow past the corner. Alternatively, the plate may be convexly, inwardly curved so as to provide a generally circular contour for the fillet 19. In order to gasify the liquid, a sparge pipe 20 directs the gas into the lower end of the draft tube, preferably in proximity to the tips (the radially outward most or peripheral ends) of the blades of the lower most impeller 12. The introduction of the gas is known as sparging. The term aeration is generally used to connote the introduction of any gas including atmospheric air or oxygen enriched air. Substantially pure (90 to 95%) oxygen may also be used. Gas dispersion or gas incorporation into the liquid also occurs due to turbulence at the liquid surface 3 where there is gas-liquid contacting and entrainment of the gas into the liquid surface so that it recirculates downwardly through the outer annular region. Because of the high shear rate in the draft tube, and in the case of a Non-Newtonian shear thinning fluid, the liquid is at low viscosity and enables the gas from the sparge pipe 20 to be broken up into fine bubbles which present a large total gas-liquid interfacial area to facilitate mass transfer. The effectiveness of gas-liquid mass transfer may be measured in terms of the overall liquid phase mass transfer coefficient (K_{La}).

In order to provide the high shear conditions (high shear rate sufficient to reduce the viscosity of the liquid in the tank so that it can circulate readily and uniformly), the impellers 9-12 are spaced sufficiently close to each other so that the field or pattern of their flow overlaps. When the overlapping fields of flow are created, the agitation produces not only axial, but also significant radial force on the fluid. The sets 14-17 of baffles inhibit this radial component, which produces a swirling flow, so that the flow upward through the draft tube is substantially axial. The baffles preferably project radially inwardly by distances sufficient to inhibit the radial flow of the liquid. Preferably, the height of the baffles is such that the spacing between the upper and lower edges of the baffles and the adjoining impellers is the minimum to provide a practical running clearance for the impellers 9-12.

The following parameters have been found to provide suitable conditions for effective liquid circulation and mixing and mass transfer and oxygenation. It will be appreciated that the specific values which are selected, depend upon the material (liquid, liquid slurry or other medium) being circulated and aerated. The characteristics are generally listed in their order of criticality. It is a feature of these preferred mixing systems that these parameters are used so as to secure the benefits of efficient liquid mixing and circulation and effective gas-liquid contacting (mass transfer), especially in bio-reaction processes. The parameters are as follows:

1. The ratio of the draft tube diameter to the tank diameter is between about 0.3 and 0.85, preferably between about 0.35 and 0.75, with a ratio of about ⅔ (0.667) being presently preferred.

2. The ratio of impeller diameter to draft tube diameter is from about 0.4 to 0.98, preferably between about 0.5 to 0.96. All of the impellers 9-12 are generally of the same diameter between the tips of the blades. If impellers of different diameter are used, the largest diameter impeller is used in selecting this parameter, i.e. the ratio of the impeller diameter to the draft tube diameter.

3. Impeller vertical spacing, that is the distance between the mean height of the impeller, as measured between the leading and trailing edges of the blades thereof, is from about 0.60 to 1.40, preferably between 0.70 and 1.30, and most preferably between about 0.75 and 1.25 of the diameter of the largest of two adjacent impellers. In other words, where the adjacent impellers have the same diameter, they may be from about 0.60 to 1.40, preferably from about 0.70 to 1.30, and most preferably between about 0.75 and 1.25 of an impeller diameter apart. Where the adjacent impellers have different diameters, the largest diameter is used to determine spacing. Preferably, the impellers are spaced apart so that their midlines are separate by about 1.0 impeller diameter.

4. The ratio of the radial width of the vertical baffles inside the draft tube to the diameter of the draft tube is preferably in the range of about 0.05 to 0.4 or from about 0.1 to 0.4. A ratio of about 0.33 of radial width to draft tube diameter is presently preferred. The height of the baffles in the vertical direction should approach the impellers, and preferably be adjacent thereto, allowing only sufficient spacing for rotation of the impellers without interference.

5. There preferably are two to four baffles in each set of baffles adjoining the impellers.

6. In normal operation, the upper end of the draft tube may be submerged from the liquid surface up to about 0.3 of the diameter of the draft tube. In cases where a surface aeration impeller is used or where a diverting shroud is used, the submergence of the draft tube may be sufficient to enable insertion of the surface aerator and/or the flow diverter at the top of the draft tube. However, the volume of the liquid in the tank occupied by the draft tube should remain substantial and be at least about 0.25 of the volume of the liquid in the tank (between the bottom of the tank, the liquid level and within the sidewalls of the tank). The uppermost impeller should also be less than about one impeller diameter from the surface of the liquid in the tank. The placement of the uppermost impeller is selected which engenders good surface turbulence and further gas-liquid contacting for enhancing the gas transfer rate and the mass transfer coefficient of the system.

7. The off-bottom clearance of the bottom of the draft tube is preferably from about 0.3 to about 0.7 of the draft tube diameter. The preferred parameter is 0.5 of the draft tube diameter for the spacing or off-bottom clearance of the bottom or lower end of the draft tube from the bottom of the tank.

### EXAMPLES

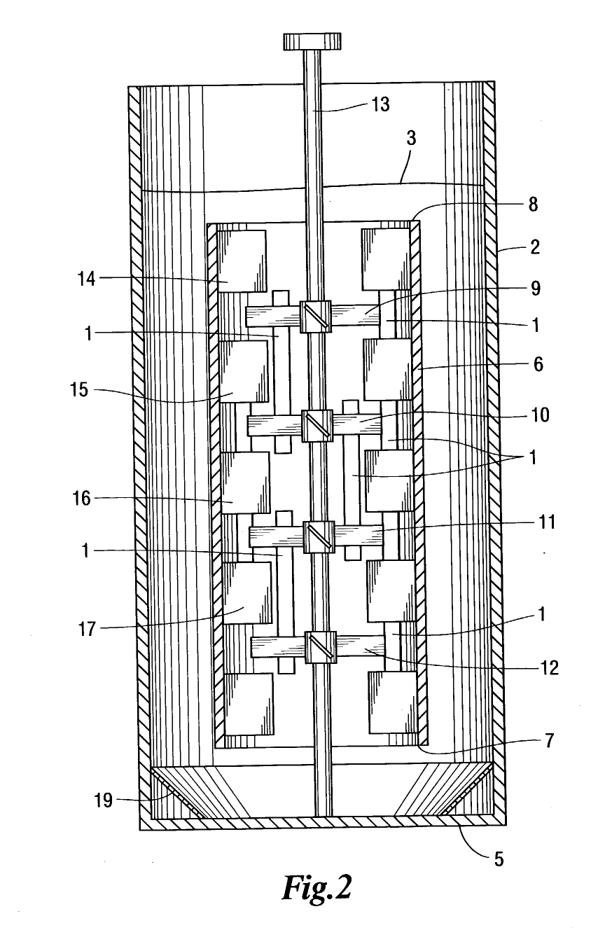

Computational Fluid Dynamics Simulation of turbulent mixing using sliding-mesh models for the impellers were run on two draft tube mixing system designs according to the invention (FIG. 2) and compared with the same mixing system using a solid, non-perforated draft tube. The system comprises a tank of 36 inch diameter and 84 inch height operating at a fluid level of about 72 inches. In the tank is a fully submerged draft tube of 24 inch diameter and 56.7 inch height clearing the bottom of the tank by about 9 inches. The bottom of the tank is filleted with an annular ring of 9 inch width and positioned at a 45° angle. The system uses a centrally positioned shaft containing four axial flow impellers spaced apart by 14.2 inches and located inside the draft tube. The draft tube also contains five sets of baffles clearing the impellers by 2 inches. The draft tube contains vertical slots (except the control) similar in design to FIG. 3D. Additional parameters and the results are shown below.

| | | Solid Draft | | |
|---|---|---|---|---|
| Parameters | Units | Tube | Example 1 | Example 2 |
| Slot width | inches | | 2.26 | 0.53 |
| Diameter | | | | |
| Slot Hydraulic | inches | | 4.1 | 1.0 |
| Slot area/ | | 0% | 26% | 6% |
| (Slot area + tube | | | | |
| area) | | | | |
| Shaft Speed | Rev/min | 260 | 260 | 260 |
| Shaft Power Draw | HP/1000 gal | 22.9 | 23.9 | 22.5 |
| Mass Flows | | | | |
| Slots | kg/s | | 106.6 | 48.1 |
| Draft tube bottom | kg/s | 355.15 | 226.8 | 309.2 |
| Draft tube top | kg/s | 355.15 | 333.4 | 357.3 |
| Cross-Flow mass | | | 32% | 13% |
| flow % | | | | |

The results show that that a draft tube in this mixing system having a slot hydraulic diameter of 1.0 inches and 6% total slot area provides a cross flow mass flow percentage (slot flow as a percentage of draft tube top flow) of about 13% (example 2). If the hydraulic diameter is increased to about 4 inches and total slot area to 26% then the cross flow mass flow percentage increases to about 32%. One interpretation of these results is that if a cross flow percentage of about 20 to 40% is targeted to provide sufficient cross flow through the draft tube wall without reducing axial flow too much, then example 2 probably has a slot hydraulic diameter and total slot area that is too low or near the lower limit of desirable operating parameters. Slotted draft tubes permitting a minimum of at least 10% or even at least 15% of cross flow through the draft tube wall (measured when the draft-tube is completely submerged) are preferred. Note that these results are for a fluid that is water-like. Any fluids having a higher viscosity than water would require a draft tube with a higher total slot area to achieve equivalent cross flow percentages.

While the invention has been particularly shown and described with reference to preferred embodiments thereof, it will be understood by those skilled in the art that various alterations in form and detail may be made therein without departing from the spirit and scope of the invention. In particular, while the invention illustrated by the figures shows specific designs and positioning of the perforations, these parameters may be varied within the scope of the invention as described herein. Further, while a preferred type of mixing system comprising the improved draft tube has been described herein, the inventive draft tube can be used in virtually any mixing system containing a draft tube.

What is claimed is:

1. A draft tube fluid mixing system, wherein said draft tube contains slots, perforations, or openings of a size and quantity that provides cross flow of fluid through the draft tube wall sufficient to provide effective mixing when the draft tube is not fully submerged.

2. The draft tube fluid mixing system according to claim 1 wherein the slots, perforations, or openings are of a size and quantity that provides at least 15% cross flow through the draft tube wall.

3. The draft tube fluid mixing system according to claim 1 wherein the slots, perforations, or openings are of a size and quantity that provides from 20-40% cross flow through the draft tube wall.

4. The draft tube fluid mixing system according to claim 1 wherein the total surface area of the perforations as a percentage of the total inside surface area of the draft tube is from 5 to 50%.

5. The draft tube fluid mixing system according to claim 4 wherein the total surface area of the perforations as a percentage of the total inside surface area of the draft tube is from 6 to 30%.

6. The draft tube fluid mixing system according to claim 1 wherein the perforations are a series of geometric shapes having a hydraulic diameter of from about 1 to 12 inches.

7. The draft tube fluid mixing system according to claim 6 wherein the perforations are a series of geometric shapes having a hydraulic diameter of greater than 2 inches.

8. The draft tube fluid mixing system according to claim 6 wherein the perforations comprise vertical rectangular slots.

9. The draft tube fluid mixing system according to claim 8 wherein the perforations on adjacent columns are vertically offset such that a fluid filling said draft tube is capable of cross flow through the draft tube wall along substantially the entire length of the draft tube.

10. The draft tube fluid mixing system according to claim 1 wherein the perforations are of a quantity and position such that a fluid filling said draft tube is capable of cross flow through the draft tube wall along substantially the entire length of the draft tube.

11. The draft tube fluid mixing system according to claim 1 wherein the perforations are vertically positioned rectangular openings wherein the height of each rectangular opening is at least ⅕^{th} the height of the draft tube.

12. The draft tube fluid mixing system according to claim 1 wherein the draft tube has a means for varying the size of the slots, perforations or openings.

13. The draft tube fluid mixing system according to claim 1 wherein the draft tube has one or more flared or flanged ends.

14. The draft tube fluid mixing system according to claim 1 wherein the draft tube has multiple zones along its axis and wherein one or more zones have slots of a different shape or hydraulic diameter of those in another zone.

15. A mixing system for mixing a fluid in a tank comprising:
a) a tank;
b) a substantially cylindrical draft tube disposed vertically within said tank; and
c) multiple mixing impellers on a shaft and positioned within said draft tube;
wherein said draft tube contains slots, perforations, or openings of a size and quantity that provides cross flow of fluid through the draft tube wall sufficient to provide effective mixing when the draft tube is not fully submerged.

16. The mixing system according to claim 15 wherein the slots, perforations, or openings are of a size and quantity that provides at least 15% cross flow through the draft tube wall.

17. The mixing system according to claim 15 wherein the slots, perforations, or openings are of a size and quantity that provides from 20-40% cross flow through the draft tube wall.

18. The mixing system according to claim 15 wherein the total surface area of the perforations as a percentage of the total inside surface area of said draft tube is from 5 to 50%.

19. The mixing system according to claim 18 wherein the total surface area of the perforations as a percentage of the total inside surface area of said draft tube is from about 10 to 30%.

20. The mixing system according to claim 15 wherein the perforations comprise columns of geometric shapes having a hydraulic diameter of from about 1 to 12 inches.

21. The mixing system according to claim 15 wherein the perforations are a series of geometric shapes having a hydraulic diameter of greater than 2 inches.

22. The mixing system according to claim 15 wherein the perforations comprise vertical rectangular sections.

23. The mixing system according to claim 15 wherein the perforations are rectangular sections that are inclined from the vertical.

24. The mixing system according to claim 15 wherein the perforations are of a quantity and position such that a fluid filling said tank and draft tube is capable of cross flow through the draft tube wall along substantially the entire length of the draft tube.

25. The mixing system according to claim 20 wherein the perforations on adjacent columns are vertically offset such that a fluid filling said tank and draft tube is capable of cross flow through the draft tube wall along substantially the entire length of the draft tube.

26. The mixing system according to claim 15 wherein the draft tube has a means for varying the size of the slots, perforations or openings.

27. The mixing system according to claim 15 wherein the draft tube has one or more flared or flanged ends.

28. The mixing system according to claim 15 wherein the draft tube has multiple zones along its axis wherein one or more zones have slots of a different shape or hydraulic diameter than those in another zone.

29. A system for circulating a liquid medium in a tank, said system comprising:
a) a tank for holding said liquid medium;
b) a slotted or perforated draft tube positioned entirely within said tank and defining a generally cylindrical region within the draft tube and an annular region between the draft tube wall and the tank wall;
c) a plurality of impellers disposed in said draft tube and rotatable about an axis which establish flow of said liquid medium in opposite directions in said cylindrical and annular regions; and
d) a plurality of baffles positioned within said draft tube having a radial width extending from said draft tube toward said axis and extending axially between said impellers;
wherein the ratio of the draft tube diameter to the tank diameter is within the range of about 0.3 to 0.85 and wherein said impellers are positioned from one another along said axis and wherein the ratio of the radial width of said baffles to the diameter of said draft tube is at least 0.05 and wherein said slots or perforations are of a size and quantity that provides cross flow of the liquid through the draft tube wall that is sufficient to provide effective mixing when the draft tube is not fully submerged.

30. The system according to claim 29 wherein said impellers are positioned from one another along said axis within a distance of about 0.6 to 1.4 impeller diameters.

31. A method of mixing a fluid in a tank comprising:
a) providing a mixing system comprising a tank, a slotted draft tube positioned completely within said tank, and one or more mixing impellers positioned within said draft tube; and
b) operating said mixing system in a manner such that said slotted draft tube is not fully submerged.
